(19) United States
(12) Patent Application Publication
(10) Pub. No.: US 2016/0187900 A1
(43) Pub. Date: Jun. 30, 2016

(54) VOLTAGE REGULATOR CIRCUIT AND METHOD FOR LIMITING INRUSH CURRENT

(71) Applicants: Kailash Dhiman, Ghaziabad (IN); Nidhi Chaudhry, Ghaziabad (IN); Divya Tripathi, Noida (IN)

(72) Inventors: Kailash Dhiman, Ghaziabad (IN); Nidhi Chaudhry, Ghaziabad (IN); Divya Tripathi, Noida (IN)

(21) Appl. No.: 14/582,209

(22) Filed: Dec. 24, 2014

(51) Int. Cl. G05F 1/46

(52) U.S. Cl. CPC G05F 1/46

(57) ABSTRACT

A voltage regulator circuit with two series connected resistors connected together at a common resistor node. An initial conducting path has a first pass transistor with a first terminal connected to a first supply rail and a second terminal connected to a regulated output voltage. A main conducting path has a second pass transistor with a first terminal connected to the first supply rail and a second terminal connected to the regulated output voltage. A comparator has an input connected to the common resistor node output is connected to a gate of the first pass transistor. A voltage threshold switch is connected to the common resistor node, and based on the voltage at the common resistor node the voltage threshold switch selectively connects a gate of the second pass transistor to the comparator output.

### BACKGROUND

The present invention relates generally to a voltage regulator circuit, and more particularly to a voltage regulator circuit that limits inrush current during startup.

Voltage regulator circuits are used in many kinds of electrical and electronic devices. Typically, a voltage regulator circuit provides a stable DC (Direct Current) output voltage with little fluctuation to a load. Generally, such voltage regulator circuits rely on a feedback voltage to maintain the stable output voltage. That is, an error signal whose value is a function of the difference between the actual output voltage and a reference value is amplified and used to control current flow through a pass device such as a power transistor, from the power supply to a resistance circuit connected in parallel with the load. However, during start up the error signal can be excessively large. This excessively large error signal may cause an undesirable high inrush (transient) current through the power transistor, which in turn results in an undesirably high current through the load.

### BRIEF DESCRIPTION OF THE DRAWINGS

The invention, together with objects and advantages thereof, may best be understood by reference to the following description of preferred embodiments together with the accompanying drawings in which:

FIG. 1 is a schematic circuit diagram of a voltage regulator circuit according to an embodiment of the present invention;

FIG. 2 is a schematic circuit diagram of an alternative implementation of the voltage threshold switch forming part of the voltage regulator circuit of FIG. 1, according to another embodiment of the present invention; and

FIG. 3 is a flow chart showing a method of limiting inrush current in a voltage regulator circuit according to an embodiment of the present invention.

### DETAILED DESCRIPTION OF PREFERRED EMBODIMENTS

The detailed description set forth below in connection with the appended drawings is intended as a description of presently preferred embodiments of the invention, and is not intended to represent the only forms in which the present invention may be practised. It is to be understood that the same or equivalent functions may be accomplished by different embodiments that are intended to be encompassed within the spirit and scope of the invention. In the drawings, like numerals are used to indicate like elements throughout. Furthermore, terms “comprises,” “comprising,” or any other variation thereof, are intended to cover a non-exclusive inclusion, such that module, circuit, device components, structures and method steps that comprises a list of elements or steps does not include only those elements but may include other elements or steps not expressly listed or inherent to such module, circuit, device components or steps. An element or step proceeded by “comprises _a” does not, without more constraints, preclude the existence of additional identical elements or steps that comprises the element or step.

In one embodiment, the present invention provides a voltage regulator circuit comprising two series resistors connected together at a common resistor node. There is an initial conductive path including a first pass transistor with a first terminal connected to a first supply rail and a second terminal connected to a second supply rail through the two series connected resistors. The second terminal of the first pass transistor is connected to a regulated voltage output node. There is also a main conducting path including a second pass transistor with a first terminal connected to the first supply rail and a second terminal connected to the second supply rail through the two series connected resistors. The second terminal of the second pass transistor is connected to the regulated voltage output node. There is a comparator with a first comparator input connected to a reference voltage, a second comparator input connected to the common resistor node and a comparator output connected to a control node of the first pass transistor. The voltage regulator circuit also includes a voltage threshold switch with a voltage sensing input node connected to the common resistor node, an input switch node connected to the comparator output and an output switch node connected to a control node of the second pass transistor. The voltage regulator circuit is configured so that when the first pass transistor and second pass transistor are both conducting, current flowing through the first pass transistor is less than current flowing through the second pass transistor.

In another embodiment, the present invention provides for a method of limiting inrush current in a voltage regulator circuit, the method comprising comparing a voltage at a common resistor node with a reference voltage to provide an error signal voltage. The method provides for controlling an inrush current in an initial conducting path using the error signal voltage which controls a first pass transistor that has a first terminal connected to a first supply rail and a second terminal connected to a regulated voltage output node. The method also performs controlling an inrush current in a main conducting path with the error signal voltage when the common resistor node reaches a threshold voltage value. The main conducting path includes a second pass transistor with a first terminal connected to the first supply rail and a second terminal connected to the regulated voltage output node, and wherein when the first pass transistor and second pass transistor are both conducting, current flowing through the first pass transistor is less than current flowing through the second pass transistor.

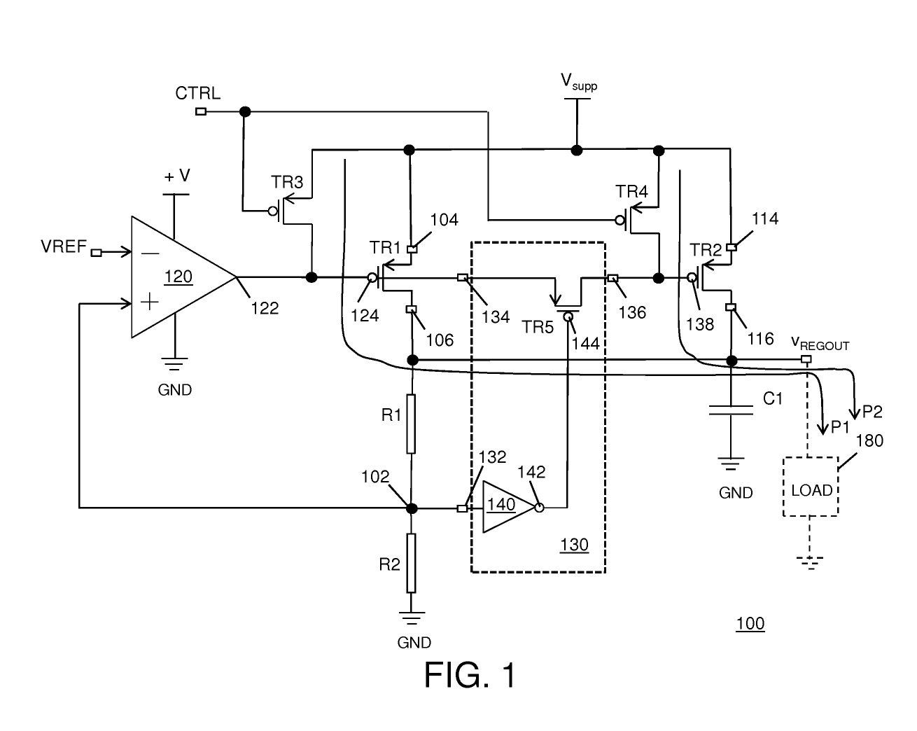

Referring now to FIG. 1, there is illustrated a circuit diagram of a voltage regulator circuit 100 according to an embodiment of the present invention. The voltage regulator circuit 100 includes two series connected resistors R1, R2 connected together at a common resistor node 102. A first pass transistor TR1 with a first terminal 104 (source terminal) is connected to a first supply rail VSUPP (a positive rail) and a second terminal 106 (drain terminal) is connected to a second supply rail, which is a ground rail GND, through the two series connected resistors R1, R2. Also, the second terminal 106 of the first pass transistor TR1 is connected to a regulated voltage output node VREGOUT which provides a regulated voltage output from the voltage regulator circuit 100 to a load 180.

A second pass transistor TR2 with a first terminal 114 is connected to the first supply rail VSUPP and a second terminal 116 is connected to the second supply rail GND through the two series connected resistors R1, R2. Also, the second terminal 116 of the second pass transistor is connected to the regulated voltage output node VREGOUT.

The voltage regulator circuit 100 also includes a comparator 120 with a first comparator input (inverting input −) connected to a reference voltage node VREF, a second comparator input (non-inverting input +) connected to the common resistor node 102 and a comparator output 122 connected to a control node 124 (gate terminal) of the first pass transistor TR1.

There is also a voltage threshold switch 130 with a voltage sensing input node 132 connected to the common resistor node 102, an input switch node 134 connected to the comparator output 122 and an output switch node 136 connected to a control node 138 (gate terminal) of the second pass transistor TR2.

The voltage regulator circuit 100 further includes a first control switch TR3 in the form of a transistor connected to the first pass transistor TR1, the first control switch TR3 being arranged to selectively switch off the first pass transistor TR1. More specifically, in this embodiment the first pass transistor TR1 is a P-channel Field Effect Transistor (FET) and thus the first control switch TR3 is connected across the control node 124 and first terminal 104 (source) of the first pass transistor TR1. With this configuration, when a circuit control node CTRL connected to a gate terminal of the first control switch TR3 (a P-channel FET) is low (GND), the first control switch TR3 is conducting. In this state, the Gate to Source voltage (Vgs) for the first pass transistor TR1 is zero thereby switching off the first pass transistor TR1.

There is also a second control switch TR4 in the form of a transistor (a P-channel FET) connected to the second pass transistor TR2, the second control switch TR4 being arranged to selectively switch off the second pass transistor TR2. More specifically, in this embodiment the second pass transistor TR2 is a P-channel FET and thus the second control switch TR4 is connected across the control node 138 and first terminal 114 (source) of the second pass transistor TR2. With this configuration, when the circuit control node CTRL which is connected to a gate terminal 138 of the second control switch TR4 is low (GND), the second control switch TR4 is conducting. In this state, the Gate to Source voltage (Vgs) for the second pass transistor TR2 is zero thereby switching off the second pass transistor TR2.

In this embodiment there is a load capacitor C1 connected between the regulated voltage output node VREGOUT and the second supply rail GND. Also in this embodiment, the voltage threshold switch 130 comprises a switch transistor TR5 connected across the input switch node 134 and output switch node 136. In this example the switch transistor TR5 is a Field Effect Transistor but it may be any switching device such as a transmission gate.

The voltage threshold switch 130 also includes an inverter 140 having an inverter input providing the voltage sensing input node 132 and an inverter output 142 connected to a control terminal 144 (gate terminal) of the switch transistor TR5.

The voltage regulator circuit 100 is configured and biased so that when the first pass transistor TR1 and second pass transistor TR2 are both conducting so that they have equal gate to sources voltages, current flowing through the first pass transistor is less than current flowing through the second pass transistor. In other words the first pass transistor TR1 has lower driving capability than the second pass transistor TR2. This is because the channel cross section and maximum current rating (aspect ratio) of TR1 is smaller than the channel cross section and maximum current rating of TR2. In one embodiment, the second pass transistor TR2 has an aspect ratio greater than that of the first pass transistor TR1.

In operation, when the circuit control node CTRL transitions from low (GND) to high (VSUPP) an initial activation of the voltage regulator circuit 100 occurs. During this initial activation, a feedback voltage value FVV at the common resistor node 102 is at the ground potential of the second supply rail GND. This feedback voltage value FVV drives the comparator output 122 close to ground potential resulting in a maximum error signal voltage (Vgs) at the control node 124. The first pass transistor TR1 is therefore fully switched on and an initial inrush current IR is caused to flow through the first pass transistor TR1. This initial inrush current IR increases the feedback voltage value FVV at the common resistor node 102 which in turn reduces the error signal voltage (Vgs) at the control node 124. This reduction in error signal voltage (Vgs) reduces the conductivity of first pass transistor TR1 thereby reducing the inrush current IR. Hence, the inrush current IR through the first pass transistor TR1 is regulated by varying an error signal voltage (Vgs) between the comparator output 122 and first supply rail VSUPP. This error signal voltage (Vgs) controls the conductivity of the first pass transistor TR1 by the comparator 120 monitoring the feedback voltage value FVV at the common resistor node 102. Thus, the conductivity of the first pass transistor TR1 limits an output voltage VOUT at the regulated voltage output node VREGOUT.

When the voltage sensing input node 132 reaches a threshold voltage value VTH, a logic value at the inverter output 142 toggles from logic 1 to logic zero thereby causing the switch transistor TR5 to conduct. Consequently, the voltage threshold switch 130 connects the control node 138 of the second pass transistor TR2 to the comparator output 122. As a result, the error signal voltage (Vgs) at the comparator output 122 controls conductivity of the second pass transistor TR2 and thereby regulates the output voltage at the regulated voltage output node VREGOUT. As will be apparent to a person skilled in the art, that resistance values of one or both of the two series connected resistors R1, R2 can be selected depending on the required threshold voltage value VTH.

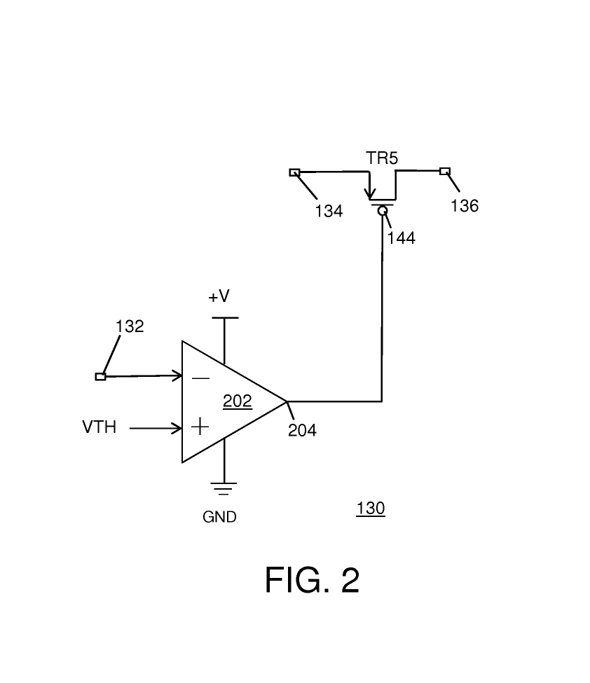

Referring now to FIG. 2 there is illustrated a circuit diagram of an alternative implementation of the voltage threshold switch 130 according to another embodiment of the present invention. In this embodiment the voltage threshold switch comprises the switch transistor connected across the input switch node 134 and output switch node 136. There is also a threshold voltage detecting comparator 202 having a reference input non-inverting input +) connected to a node providing the threshold voltage value VTH. The comparator 202 also has a monitoring input (inverting input −) providing the voltage sensing input node and comparator output 204 connected to the control terminal 144 of the switch transistor TR5. In operation, when the voltage sensing input node reaches 132 the threshold voltage value VTH, a voltage at the comparator output 204 causes the switch transistor TR5 to conduct.

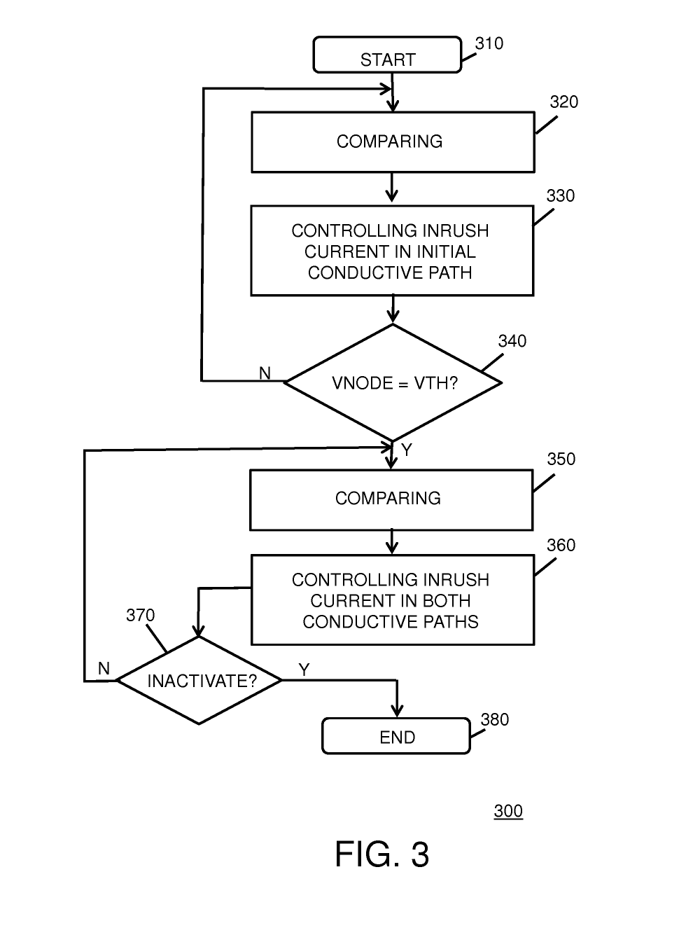

Referring now to FIG. 3, a flow chart showing a method 300 of limiting inrush current in a voltage regulator circuit according to an embodiment of the present invention is shown. By way of example only the method 300 will be described with reference to the voltage regulator circuit 100. At a start block 310, the method 300 is initiated when the circuit control node CTRL transitions from low (GND) to high (VSUPP). There is then performed, at a comparing block 320, a process of comparing the feedback voltage value FVV at the common resistor node 102 with a reference voltage at the reference voltage node VREF to provide an error signal voltage at the comparator output 122.

At a controlling block 330 there is performed a process of controlling an inrush current in the initial conducting path P1 with the error signal voltage applied to the control node 124 of the first pass transistor TR1. A test block 340 determines if the feedback voltage value FVV at the common resistor node 102 has reached the threshold voltage value VTH, if the feedback voltage value FVV has not reached the threshold voltage value VTH then blocks 320 and 330 are repeated. Alternatively, if the feedback voltage value FVV at the common resistor node 102 has reached the threshold voltage value VTH, then there is performed, at a comparing block 350, the continuing process of comparing the feedback voltage value FVV at the common resistor node 102 with a reference voltage at the reference voltage node VREF to continually provide an error signal voltage at the comparator output 122. Next at a block 360, the controlling of the inrush current in both the main conducting path P2 and initial conducting path P1 is performed since the voltage threshold switch 130 connects the comparator output 122 to the control node 138 of the second pass transistor TR2.

If a test block 370 detects that the circuit control node CTRL has transitioned from a high (VSUPP) to a low (GND) the method ends 300, at a block 380, otherwise the method 300 continues to repeat blocks 350 to 370.

Advantageously, the present invention reduces the effects of excessive undesirably high inrush (transient) currents since the inrush current is initially limited by the conducting characteristics of the first pass transistor TR1. Only when the voltage sensing input node 132 reaches a threshold voltage value VTH does the second pass transistor TR2 start conduct by which time the error signal voltage to both gates of transistors TR1 and TR2 is significantly reduced.

The description of the preferred embodiments of the present invention has been presented for purposes of illustration and description, but is not intended to be exhaustive or to limit the invention to the forms disclosed. It will be appreciated by those skilled in the art that changes could be made to the embodiments described above without departing from the broad inventive concept thereof. It is understood, therefore, that this invention is not limited to the particular embodiment disclosed, but covers modifications within the spirit and scope of the present invention as defined by the appended claims.

1. A voltage regulator circuit comprising:
two series connected resistors connected together at a common resistor node;
a first pass transistor with a first terminal connected to a first supply rail and a second terminal connected to a second supply rail through the two series connected resistors, the second terminal of the first pass transistor being connected to a regulated voltage output node;
a second pass transistor with a first terminal connected to the first supply rail and a second terminal connected to the second supply rail through the two series connected resistors, the second terminal of the second pass transistor being connected to the regulated voltage output node;
a comparator with a first comparator input connected to a reference voltage line, a second comparator input connected to the common resistor node and a comparator output connected to a control node of the first pass transistor; and
a voltage threshold switch with a voltage sensing input node connected to the common resistor node, an input switch node connected to the comparator output and an output switch node connected to a control node of the second pass transistor,
wherein the voltage regulator circuit is configured so that when the first pass transistor and second pass transistor are both conducting, current flowing through the first pass transistor is less than current flowing through the second pass transistor, and wherein when the voltage sensing input node reaches a threshold voltage value, the voltage threshold switch connects the control node of the second pass transistor to an error signal voltage at the comparator output so that the comparator output controls conductivity of the second pass transistor, thereby regulating the output voltage at the regulated voltage output node.

2. The voltage regulator circuit of claim 1, wherein during initial activation of the voltage regulator circuit an inrush current is regulated by the error signal voltage at the comparator output that controls conductivity of the first pass transistor by monitoring a feedback voltage value at the common resistor node.

3. The voltage regulator circuit of claim 2, wherein the conductivity of the first pass transistor limits the inrush current.

4. The voltage regulator circuit of claim 1, wherein the second pass transistor has an aspect ratio greater than that of the first pass transistor.

5. The voltage regulator circuit of claim 1, further comprising a first control switch connected to the first pass transistor, the first control switch being arranged to selectively switch off the first pass transistor.

6. The voltage regulator circuit of claim 5, wherein the first control switch is connected across the control node and first terminal of the first pass transistor.

7. The voltage regulator circuit of claim 6, further comprising a second control switch connected to the second pass transistor, wherein the second control switch selectively switches off the second pass transistor.

8. The voltage regulator circuit of claim 7, wherein the second control switch is connected across the control node and first terminal of the second pass transistor.

9. The voltage regulator circuit of claim 1, further comprising a capacitor connected between the regulated voltage output node and the second supply rail.

10. The voltage regulator circuit of claim 1, wherein the voltage threshold switch comprises:
a switch transistor connected across the input switch node and output switch node, and
an inverter having an inverter input providing the voltage sensing input node and an inverter output connected to a control terminal of the switch transistor, wherein in operation when the voltage sensing input node reaches the threshold voltage value a logic value at the inverter output toggles thereby causing the switch transistor to conduct.

11. The voltage regulator circuit of claim 1, wherein the voltage threshold switch comprises:
a switch transistor connected across the input switch node and output switch node, and
a threshold voltage detecting comparator having a reference input connected to a node providing the threshold voltage value, a monitoring input providing the voltage sensing input node and comparator output connected to a control terminal of the switch transistor, wherein in operation when the voltage sensing input node reaches the threshold voltage value, a voltage at the comparator output causes the switch transistor to conduct.

12. A method of limiting inrush current in a voltage regulator circuit, the method comprising:
comparing a voltage at a common resistor node with a reference voltage to provide an error signal voltage;
controlling an inrush current in an initial conducting path with the error signal voltage, which controls a first pass transistor that has a first terminal connected to a first supply rail and a second terminal connected to a regulated voltage output node; and
controlling an inrush current in a main conducting path with the error signal voltage when the common resistor node reaches a threshold voltage value, wherein the main conducting path includes a second pass transistor with a first terminal connected to the first supply rail and a second terminal connected to the regulated voltage output node,
wherein when the first pass transistor and second pass transistor are both conducting, current flowing through the first pass transistor is less than current flowing through the second pass transistor, and wherein when the voltage sensing input node reaches a threshold voltage value, the voltage threshold switch connects the control node of the second pass transistor to the error signal voltage at the comparator output so that the comparator output controls conductivity of the second pass transistor, thereby regulating the output voltage at the regulated voltage output node.

13. The method of limiting inrush current of claim 12, wherein during initial activation of the voltage regulator circuit the inrush current through the first pass transistor is regulated by varying the error signal voltage at the comparator output that controls conductivity of the first pass transistor by monitoring a feedback voltage value at the common resistor node.

14. The method of limiting inrush current of claim 13, wherein the conductivity of the first pass transistor limits the inrush current.

15. The method of limiting inrush current of claim 12, wherein the second pass transistor has an aspect ratio greater than that of the first pass transistor.
